(19) United States
(12) Patent Application Publication
(10) Pub. No.: US 2002/0053579 A1
(43) Pub. Date: May 9, 2002

(54) Container cap with pivoting dispensing nozzle

(76) Inventors: Richard J. Baumgart, Paris, KY (US); Zhiqiang Zhang, Lexington, KY (US); Steve B. Ruble, Lexington, KY (US)

Correspondence Address: David W. Carrithers, CARRITHERS LAW OFFICE, One Paragon Centre, 6060 Dutchman's Lane, Suite 140, Louisville, KY, 40205, US

(21) Appl. No.: 09/920,540

(22) Filed: Aug. 1, 2001

Related U.S. Application Data
(60) Provisional application No. 60/246,783, filed on Nov. 8, 2000.

(51) Int. Cl. B67D 3/00

(52) U.S. Cl. 222/527; 222/529

(57) ABSTRACT

An adjustable dispensing nozzle for an aerosol container in which pivotally interconnected elbows have a positionable extension tube extending from one elbow and a stem on the other elbow inserted into and pivotal in a socket on a valve actuating lever of a cap mounted on the container. Means for dispensing a spray may be incorporated within the stem of the dispensing nozzle.

This application claims priority from U.S. Provisional Application Ser. No. 60/246,783 filed Nov. 8, 2000.

### FIELD OF INVENTION

This invention relates generally to aerosols (including aerogels) and more particularly to a flexible directional applicator tube extendable from a dispensing nozzle that of the container cap of an aerosol or foam container including a product under pressure in a container and a cap on the container.

### BACKGROUND OF INVENTION

There are numerous aerosol products (fine spray mixture) and aerogels (foams) in use today and only to mention a few they include insecticides, lubricants, paints and other coating materials, hair fixatives, shaving cream, whipped cream etc. In most all instances the contents of the pressurized container issue from an orifice in a head piece mounted on a tubular valve stem or from a tube that is insertable into a recess in the head piece that extends toward the orifice. This works well for most products with generalized targets but specific targets are often difficult if not impossible to reach. For example in applying lubricants or cleaners to specific targets the presently available dispensing means are not suitable.

### SUMMARY OF INVENTION

The present invention is an adjustable dispensing nozzle for an aerosol container in which pivotally interconnected elbows have an extension tube extending from one elbow and a stem on the other elbow inserted into and pivotal in a socket on a valve actuating lever of a cap mounted on the container.

More particularly, the present invention defines an adjustable dispensing nozzle for a liquid, foam, or aerosol in a pressurized container comprising a cap having a top wall, an annular lower wall portion mountable on an aerosol container and a valve actuating lever for depressing a tubular valve stem on the aerosol container. The valve actuating lever having a passageway communicating at one end thereof with the passageway of said tubular valve stem and at the other end with a first socket in an outer face surface of said cap. The cap includes a first elbow having a stem inserted into and rotatable in said first socket, a second elbow rotatably connected to said first elbow and an extension tube connected to said second elbow.

A principal object of the present invention is to provide a pivotally movable aerosol dispensing nozzle.

A further principal object of the present invention is to provide a cap for an aerosol container and wherein the cap has a dispensing nozzle pivotally mounted thereon.

Another object of the present invention is to provide a cap having a nozzle pivotally mounted thereon with a means for producing a mist in a conical, flat spray pattern, or stream.

Another object of the present invention is to provide a dispensing nozzle having a removable, reuseable, and extendible applicator straw including one or more bendable joint for directing and applying a stream of liquid around an object, wherein the joint allows a portion of the straw to remain bent at a selected angle until repositioned by the user.

These and other objects of the present invention will be more fully understood from the following description of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is an exploded perspective view of an aerosol dispensing container cap provided in accordance with the present invention with a pivotally mounted dispensing nozzle;

FIG. 2 is a top plan view of the assembled aerosol dispensing cap;

FIG. 3 is a sectional view taken along line 3-3 of FIG. 2;

FIG. 4 is a sectional view taken along line 4-4 of FIG. 2; and

FIG. 5 is a sectional view taken along line 5-5 of FIG. 2.

FIG. 6 is a horizontal sectional view of a diverter valve showing a valve stem having a passageway that extends through the stem (transverse to the length thereof) and a groove or channel in the outer surface of and extending lengthwise of the stem.

FIG. 7 is a side or vertical sectional view of FIG. 8;

FIG. 8 is a perspective view of the aerosol dispensing cap including the diverter valve shown in FIG. 7;

FIG. 9 shows the dispenser of FIG. 1 including a flexible directional applicator tube with a corrugated section for bending;

FIG. 10 shows the dispenser of FIG. 1 including an applicator tube formed completely from corrugated sections;

FIG. 11 shows the corrugated portion of the tube in the collapsed compressed position;

FIG. 12 shows the corrugated portion of the tube in the extended expanded position;

FIG. 13 shows the corrugated portion of the tube in the flexible bent position; and

FIG. 14 shows a can having a tube extending therefrom with a corrugated portion in the bent position.

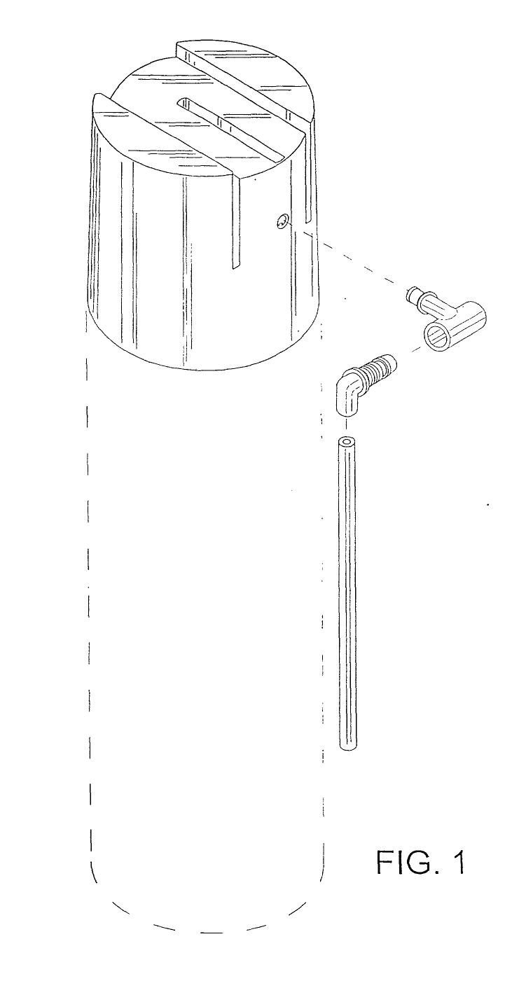

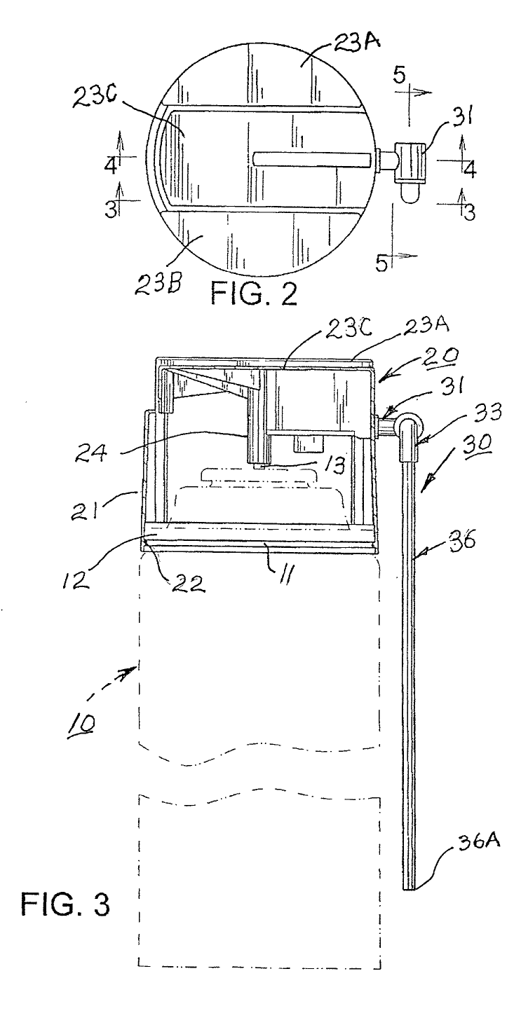

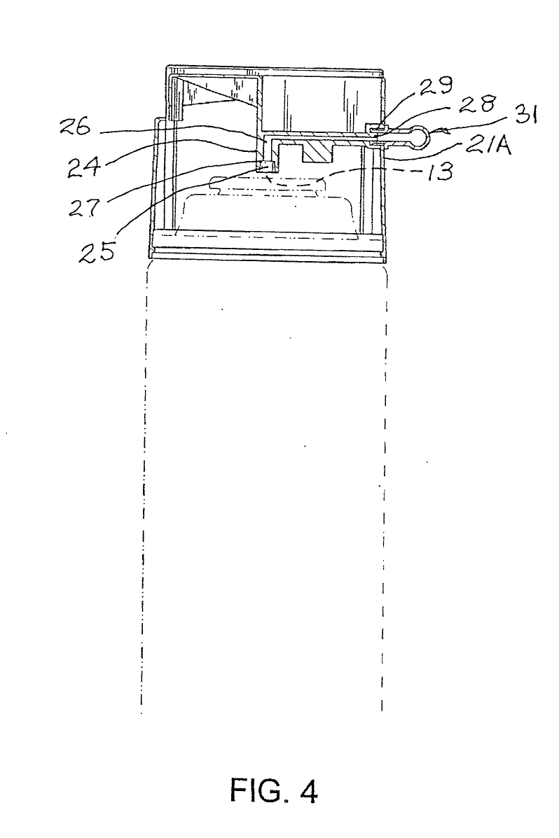

### DESCRIPTION OF THE PREFERRED EMBODIMENT

Referring to the drawings there is illustrated an aerosol container 10, a dispensing cap 20 mounted on the container and a dispensing nozzle 30 pivotally mounted on the cap 20. The cap 20 has an a cylindrical wall 21 with a rib 22 on the internal surface of the lower end thereof that snap fits into a groove 11 in a lip 12 on the upper end of the container. The cap further has a top wall comprising outer segments 23A, 23B and a valve actuating lever portion 23C disposed there between. The lever portion 23C includes a segmental portion 21A of the side wall and is canter levered therefrom extending in a direction toward a diametrically opposite portion of the side wall.

The lever portion 23C of the top wall has a stem 24 projecting downwardly from the underside thereof. A recess 25 in the bottom end of the stem 24 slip fits onto a conventional hollow valve stem 13 that projects upwardly from the center of the top of the aerosol container. The stem 24 has a passageway 26 that is smaller in diameter than the recess 25 thus providing a shoulder 27 to butt against the top end of the valve stem.

The passage 26 changes direction (90 degrees) and continues into a spigot portion 28 that projects into a circular recess 29 in the side wall segment 21A of the top 20. The pivotally mounted dispensing nozzle 30 includes a first elbow 31 having a stem 32 that press fits into the recess 29 in the cap and is rotatable therein, a second elbow 33 having a stem 34 that press fits into a socket 35 in the first elbow 31 and is rotatable therein and an extension tube 36 having an end portion that press fits into a portion 37 of the second elbow 33.

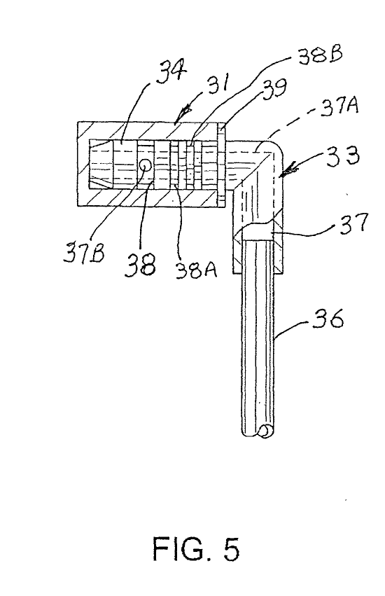

The stem 34 of the elbow 33 has an annular groove 38 that is in alignment with the flow passage in the stem 32 of elbow 31 when fully inserted into the recess. This relative positioning is predetermined by a flange 39 on the elbow 33 that abuts the elbow 31 and/or engagement of the stem with the bottom end of the recess 35 as best illustrated in FIG. 5.

The elbow 33 has a flow through passage 37A that communicates with an aperture 37B located in the groove 38. There are two further grooves designated respectively 38A and 38B in the stem 34 for receiving O-ring seals if so desired. The stem 32 of elbow 31 has an O-ring seal 32A. Suitable grooving can be provided in the receptors to maintain assembly of the components particularly when intended for use in dispensing aerogels.

The elbow 31 can be rotated 360 degrees about the axis of stem 32 and the elbow 33 can be rotated at least 180 degrees about the axis of the stem 34. This pivotal movement about the two mutually perpendicular axes permits variously positioning the discharge end 36A of the tube 36 to deliver the contents to specific hard to otherwise get at targets.

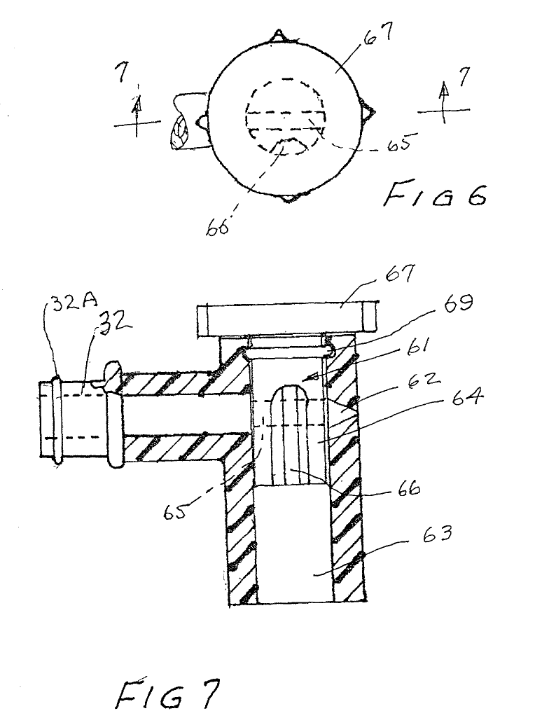

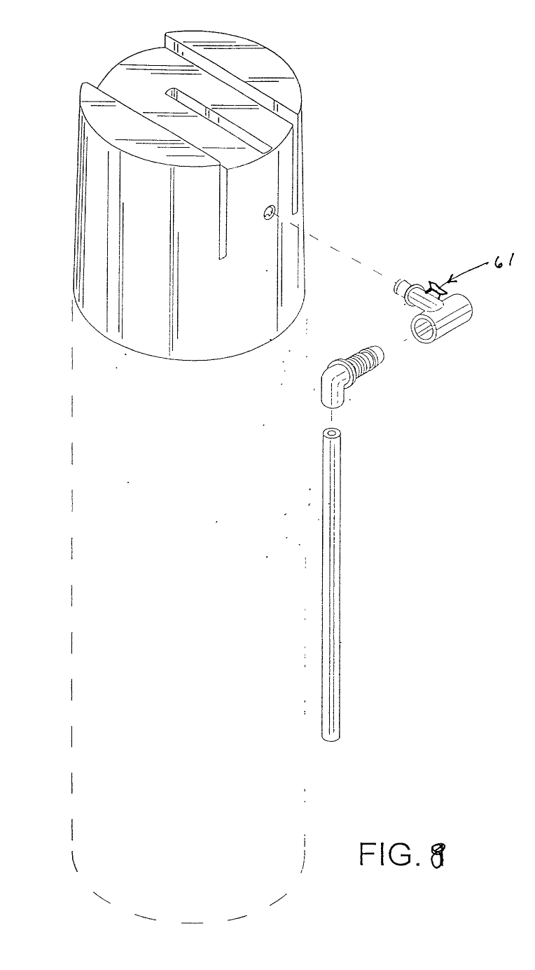

Illustrated in FIGS. 6 and 7 is an elbow 60 for use as an alternative to the previously described elbow 31. The elbow 60 has a diverter valve 61 rotatably mounted in the cylindrical body for directing the contents of the container to one or the other of an orifice 62 and a socket 63 in which the extension tube 36 can be inserted.

The diverter valve comprises a valve stem 64 having a passageway 65 that extends through the stem (transverse to the length thereof) and a groove or channel 66 in the outer surface of and extending lengthwise of the stem.

The stem is rotatable in the cylindrical body and can be turned from one position to the other of in one position aligning the passage through elbow stem 32 with the orifice 62 via passage 65 in the stem and in the other position providing communication between the passage in the elbow stem 32 and the socket 63 via the groove 66 in the side face of the valve stem. The valve stem has a finger grip knob 67 to facilitate moving the diverter valve from one position to the other. The valve stem is retained in the cylindrical body by an O-ring seal 69 fitting into suitable grooves in the body and the valve stem.

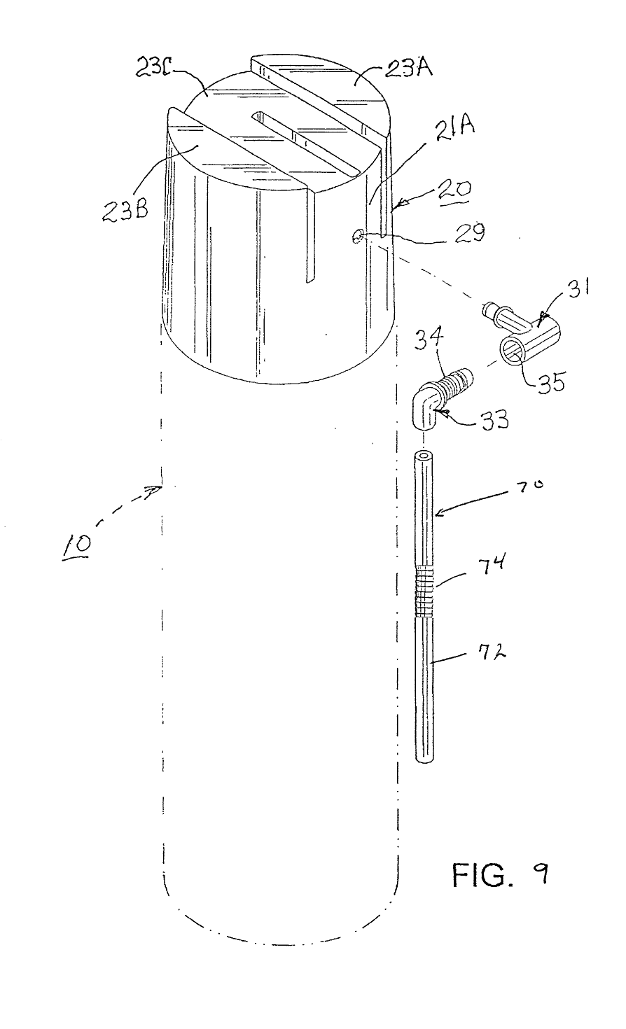

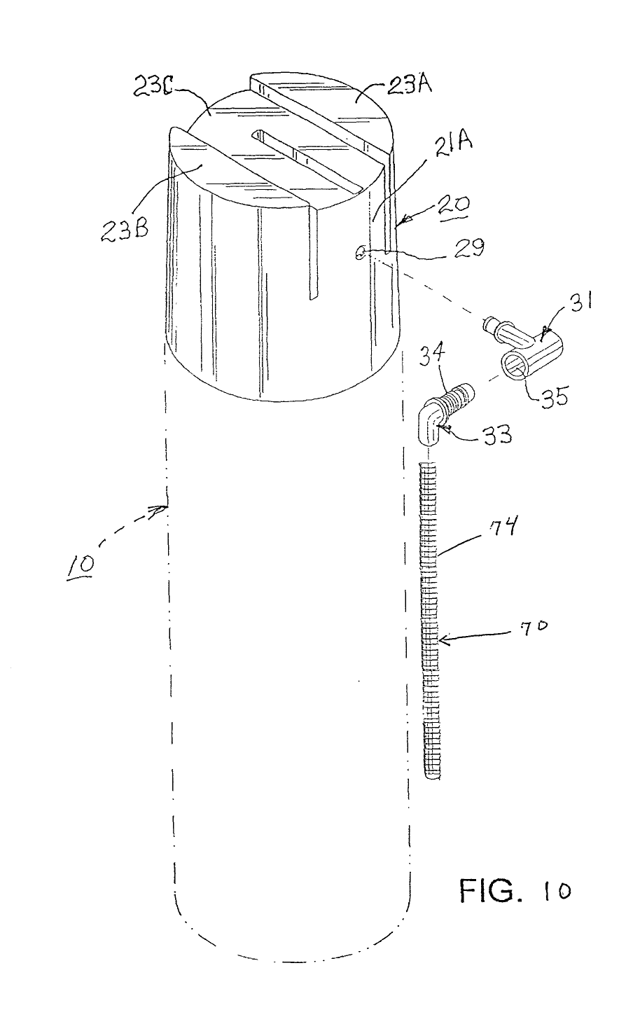

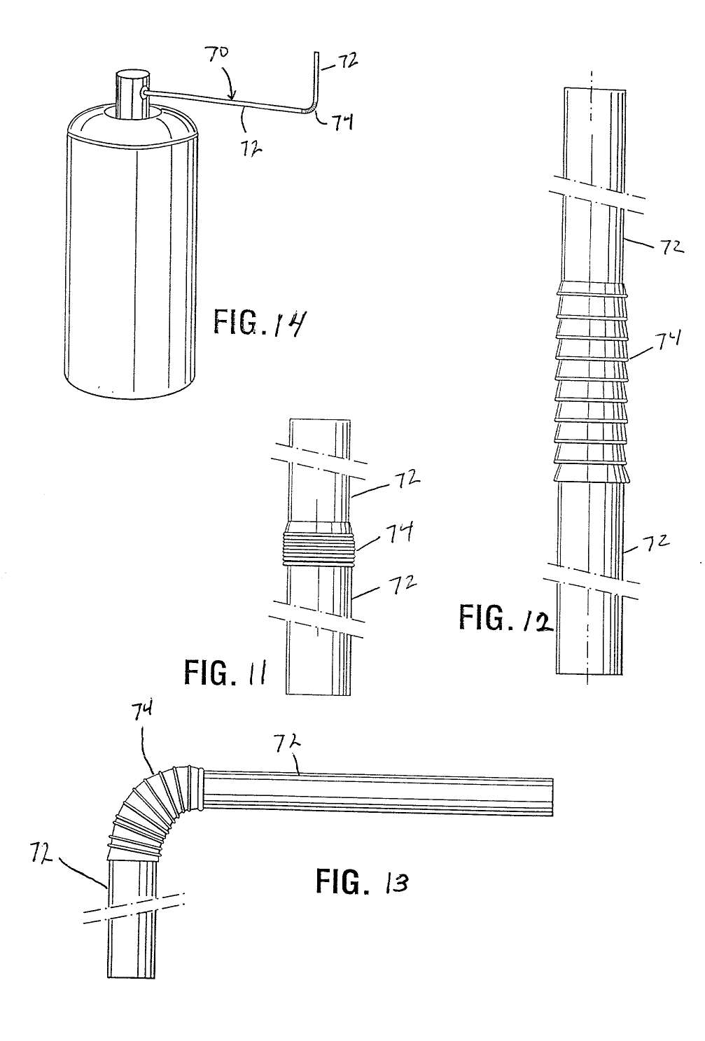

As shown in FIGS. 9-14, a flexible applicator tube 70 may further provide a degree of control to the application of the aerosol in the container. The tube 70 is as shown in FIGS. 9 and 11-14 includes a straight cylindrical portion 72 attached to a corrugated portion 74 is grooved circumferentially, one groove at a time, progressively part way toward one end of the tube, starting inwardly from a selected point, the grooves having sides of unequal length for snapping over center for flexing or straightening the tube. A straw of similar construction is taught in part in Harp et al. U.S. Pat. No. 3,409,224, and a machine for making same is taught in U.S. Pat. No. 3,641,884, both or which are incorporated by reference herein.

More particularly, each of the corrugations of section 74 is defined by a circumferential groove having sides of unequal length. The corrugations define reentrant overlapping folds when the corrugated portion 74 of the tube 70 is contracted lengthwise. Flexing the tube 70 to a desired extent results in at least some of the folds opening as the fold goes past dead center, thereby holding positioning the distal end of the tube 70 beyond the corrugations at any given set position.

When used with the dispenser cap and low viscosity fluids the applicator tube and corrugated sections may be of a selected small internal diameter. When used with a foam, gel, or expandable foam, the diameter of the applicator tube and corrugations may be sized accordingly, usually utilizing larger dimensions.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented hereinabove. Rather, what is intended to be covered is within the spirit and scope of the appended claims.

We claim:

1. An adjustable dispensing nozzle for an aerosol container comprising a cap having a top wall, an annular lower wall portion mountable on an aerosol container and a valve actuating lever for depressing a tubular valve stem on the aerosol container, said valve actuating lever having a passageway communicating at one end thereof with the passageway of said tubular valve stem and at the other end with a first socket in an outer face surface of said cap, a first elbow having a stem inserted into and rotatable in said first socket, a second elbow rotatably connected to said first elbow and an extension tube connected to said second elbow, and means for dispensing a spray from said first elbow.

2. An adjustable dispensing nozzle as defined in claim 1 wherein said first and second elbows are pivotal about respective first and second axis and wherein said axes are perpendicular to one another.

3. An adjustable nozzle as defined in claim 2 wherein said first elbow comprises a tubular member open at one end and closed at the other opposite end and wherein the stem of said first elbow projects from said tubular member.

4. An adjustable nozzle as defined in claim 3 wherein the stem of said first elbow is perpendicular to said tubular member.

5. An adjustable nozzle as defined in claim 4 wherein said second elbow has a stem projecting therefrom into said tubular member of said first elbow.

6. An adjustable nozzle as defined in claim 4 wherein said second elbow has a stem projecting therefrom, wherein said open ended tubular member provides a second socket and wherein said second elbow stem projects into said second socket.

7. An adjustable nozzle as defined in claim 6 wherein said means for dispensing a spray from said first elbow comprises a stem on said second elbow has an annular groove communicating with a passage through such elbow and wherein said groove is aligned with a flow passage in the stem in said first elbow.

8. An aerosol container having a valve operating and dispensing tube projecting upwardly therefrom, a cap mounted on said container and having a lever attached thereto that engages said valve operating tube, said lever having a passage there through communicating at one end thereof with the container valve dispensing tube and at the other end terminating in a first socket in an outer surface of said cap, a first elbow having a stem inserted into said first socket and rotatable therein, a second elbow pivotally connected to said first elbow and an extension tube connected to said second elbow.

9. An adjustable dispensing nozzle for an aerosol container comprising a cap having a top wall, an annular lower wall portion mountable on an aerosol container and a valve actuating lever for depressing a tubular valve stem on the aerosol container, said valve actuating lever having a passageway communicating at one end thereof with the passageway of said tubular valve stem and at the other end with a first socket in an outer face surface of said cap, a first elbow having a stem inserted into and rotatable in said first socket, a second elbow rotatably connected to said first elbow and an extension tube connected to said second elbow including means for bending and retaining said extension tube in desired direction.

10. An adjustable dispensing nozzle as defined in claim 9 wherein said first and second elbows are pivotal about respective first and second axis and wherein said axes are perpendicular to one another.

11. An adjustable nozzle as defined in claim 10 wherein said first elbow comprises a tubular member open at one end and closed at the other opposite end and wherein the stem of said first elbow projects from said tubular member.

12. An adjustable nozzle as defined in claim 11 wherein the stem of said first elbow is perpendicular to said tubular member.

13. An adjustable nozzle as defined in claim 12 wherein said second elbow has a stem projecting therefrom into said tubular member of said first elbow.

14. An adjustable nozzle as defined in claim 12 wherein said second elbow has a stem projecting therefrom, wherein said open ended tubular member provides a second socket and wherein said second elbow stem projects into said second socket.

15. An adjustable nozzle as defined in claim 14 including means for dispensing a spray from said first elbow. comprises a stem on said second elbow has an annular groove communicating with a passage through such elbow and wherein said groove is aligned with a flow passage in the stem in said first elbow.

16. An adjustable nozzle as defined in claim 15 wherein said means for dispensing a spray from said first elbow comprises a stem on said second elbow has an annular groove communicating with a passage through such elbow and wherein said groove is aligned with a flow passage in the stem in said first elbow.

17. An aerosol container having a valve operating and dispensing tube projecting upwardly therefrom, a cap mounted on said container and having a lever attached thereto that engages said valve operating tube, said lever having a passage there through communicating at one end thereof with the container valve dispensing tube and at the other end terminating in a first socket in an outer surface of said cap, a first elbow having a stem inserted into said first socket and rotatable therein, a second elbow pivotally connected to said first elbow and a bendable positionable extension tube connected to said second elbow.
